(19) United States
(12) Patent Application Publication
(10) Pub. No.: US 2008/0228454 A1
(43) Pub. Date: Sep. 18, 2008

(54) Method and Device for Simulating Bending of a Tube

(75) Inventors: Yann-Henri Laudrain, La Turballe (FR); Jean-Louis Lamotte, Plaisance Du Touch (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Airbus France, Toulouse (FR)

(21) Appl. No.: 11/996,137

(22) PCT Filed: Jul. 18, 2006
(86) PCT No.: PCT/FR06/01755

§ 371 Date: Jan. 18, 2008

(30) Foreign Application Priority Data
Jul. 22, 2005 (FR) 0507854

(51) Int. Cl. G06G 7/48; B21D 7/00

(52) U.S. Cl. 703/7; 72/14.8

(57) ABSTRACT

The method for simulating bending of a tube by means of at least one bending machine comprises a step of calculating at least one cycle of bending commands (30, 35) related to at least one tube-manufacturing parameter as a function of a set of tube data (10) and of a set of technological data (20). There is obtained at least one three-dimensional geometric model (40) of at least one bending machine and associated mechanical tools as a function of at least one parameter (50) derived from the cycle of bending commands calculated in this way (30, 35). In accordance with the cycle of bending commands calculated in this way (35), obtaining a three-dimensional and kinematic simulation of the process in which the tube represented in this way by the set of tube data (10) is bent by means of at least one bending machine and associated mechanical tools represented in this way by the corresponding three-dimensional geometric model (40). There is verified the possibility of manufacturing the tube by means of a bending machine and associated mechanical tools during the three-dimensional and kinematic simulation obtained in this way.

The present invention relates to simulation of bending of a tube.

It is applicable in numerous fields, and more particularly in the aeronautics field, in which tubes must be carefully designed so that they can be manufactured and installed in an aircraft.

Here there is understood by tube any transport element capable of transporting a hydraulic or pneumatic fluid, a fuel, a water flow or the like.

In the description hereinafter, it is considered that a tube is composed of straight sections joined by elbows shaped as arcs of circles, the whole being composed of a single part obtained by plastic deformation of an initially straight tube. An assembly of tubes held together by joints is designated by the term pipework. The tube thus is defined by the coordinates of its extremities, the coordinates of its break points, which define the position of elbows shaped as arcs of circles, and the ratio between the radius of curvature of the elbows and the tube diameter.

Such tubes can be manufactured on bending machines or benders, the operating principle of which is to achieve bending by coiling the tube around a tool defining the bend radius by means of a bending roller, which travels in one plane and always in the same direction. The construction of the tube is therefore implemented by successive bending operations separated by translations (always in the same direction) and rotations of the tube around its axis, for the respective purposes of positioning and orienting the bends.

In practice, the manufacturing process imposes certain limitations with regard to the minimal length of the straight sections between each break and to construction by deformation or bending of arcs of circles. These limitations are defined not only by characteristics specific to the tube, such as the material of which it is made, and its thickness, but also by characteristics of the machines used for construction of the bends.

These result in difficulties in design and manufacturing of the tube, related in the design phase to the capacity of the tube to be effectively manufactured and in the manufacturing phase to the choice of machines suitable for manufacturing it.

There are also known computer-assisted design (CAD) tools that provide significant aid to the designer by means of three-dimensional modeling of the tubes to be designed.

Nevertheless, such CAD tools do not provide the designer with aid in predicting a priori which bending machine and associated mechanical tools are suitable for or capable of correctly bending a tube defined according to predetermined criteria.

Similarly, during production, such CAD tools do not provide the operator with aid in validating a priori, on a new bending machine, an assemblage of tubes identified by a tube selection criterion, such as the tube material.

The present invention remedies these shortcomings.

It is aimed at further improving the design and manufacture of such transport elements, both in the design department and on the production line.

In particular, it is aimed in design mode at furnishing a simulation of bending with which the manufacturability of a naked or equipped tube can be checked relative to a pool of bending machines, the result of the simulation being a function of the pool of machines available at the time of realization of this simulation and evolving with the said pool.

It is also aimed in production mode at validating, on a chosen bending machine, an assemblage of tubes identified as a function of its characteristics.

It relates to a method for simulating bending of a tube by means of at least one bending machine.

According to a general definition of the invention, the simulation method comprises the following steps:
obtaining at least one set of tube data related to the definition of the three-dimensional geometric model of the tube to be bent;
obtaining at least one set of technological data related to parameters of at least one bending machine, to associated mechanical tools and/or to tube material;
calculating at least one cycle of bending commands related to at least one tube-manufacturing parameter as a function of the set of tube data and of the set of technological data obtained in this way;
obtaining at least one three-dimensional geometric model of at least one bending machine and associated mechanical tools as a function of at least one manufacturing parameter derived from the cycle of bending commands calculated in this way;
in accordance with the cycle of bending commands calculated in this way, obtaining a three-dimensional and kinematic simulation of the process in which the tube represented in this way by the set of tube data is bent by means of the bending machine and associated mechanical tools represented in this way by the corresponding three-dimensional geometric model;
verifying the possibility of manufacturing the tube by means of at least one bending machine and associated mechanical tools during the three-dimensional and kinematic simulation obtained in this way; and delivering a set of result data related to the manufacturability of the tube by the bending machine and the associated mechanical tools simulated in this way.

Such a method contributes significant aid to the designer in predicting the manufacturability of the tube by means of a chosen bending machine. It is a decision aid that can be contributed both in design mode and in production mode. In this way it permits the designer to optimize the layout and breakdown of a pipework, while taking into account factors related, at the time of design, to the effective production capacity of the tubes comprising it, and the manufacturer to optimize the choice of machines which, among the available machine pool, are appropriate for manufacture of this tube.

According to one embodiment, in the event of negative verification, it is provided that at least one parameter of the set of tube data will be modified and the simulation step will be repeated with the set of tube data modified in this way, thus making it possible to optimize the design of the tube as a function of the production resources.

According to another embodiment, in the case of positive verification, it is provided that at least one sequence of bending commands deduced from the cycle of corresponding bending commands and intended for the bending machine simulated in this way will be generated automatically, thus making it possible to optimize the manufacture of the tube by means of the prediction, used during design mode, of the manufacturability of the tube.

According to another important characteristic of the method according to the invention, the method is applied to a pool of several bending machines, and in addition the following steps are provided:
obtaining at least one three-dimensional geometric model for at least each bending machine and associated mechanical tools of the said pool as a function of at least one manufacturing parameter derived from the cycle of bending commands calculated in this way; and
repeating the simulation for each three-dimensional geometric model obtained in this way until there is obtained at least one positive result that demonstrates the manufacturability of the tube by means of at least one bending machine and associated mechanical tools belonging to the said pool of bending machines.

In this way such a method furnishes an aid to the decision pertaining to several bending machines and associated mechanical tools.

According to yet another embodiment, the step of obtaining a three-dimensional geometric model of the bending machine and associated mechanical tools repeated for each manufacturing parameter derived from the cycle of bending commands.

The simulation step can be implemented in the design department starting with the phase of definition of the tube and/or on the production line in order to prepare for manufacture of the tube.

In practice, each set of tube data contains information belonging to the group formed by information on the tube reference, the material, the outside diameter, the inside diameter, the bend radius, the crimping length necessary for installation of a joint at extremity No. 1 of the tube, the crimping length necessary for installation of a joint at extremity No. 2 of the tube, the description of the elements of the tube, the number of X, Y, Z data, the X, Y, Z coordinates of extremity No. 1, of extremity No. 2 and of the break points of the tube.

In turn, each set of technological data contains information belonging to the group formed by information on the machine reference, the tube material, the tube diameter, the tube thickness, the bend radius, the bending direction, the minimum and maximum bend angles, the dimensions, the mutual position and the possibility of repositioning of mechanical tools of the bending machine.

In turn, the parameters of the cycle of bending commands comprise information belonging to the group formed by the tube reference, the tube diameter, the radius of the bending former, the number of bending machines to be simulated, the number of bending cycles of the machine, the identifier of the machine, the number of the tube extremity, the carriage feed, the minimum reorientation, the maximum reorientation, the bend angle to be applied, the theoretical bend angle, the bend radius achieved.

Reorientation is defined as a change of position of the tube on the machine as achieved by turning the tube relative to itself, in order to permit bending in a different plane or in a direction opposite to that of the preceding bend.

In practice, the set of result data includes information belonging to the group formed by the tube reference, the tube diameter, the radius of the bending former, the number of bending machines to be simulated, the number of bending cycles of the machine, the identifier of the machine, the number of the tube extremity, the bending reserve relative to the first extremity, the bending reserve relative to the second extremity, the flow of materials necessary for manufacture, the carriage feed, the minimum reorientation, the maximum reorientation, the bend angle to be applied, the theoretical bend angle, the bend radius achieved, the theoretical distance between two nodes, the possibility for feeding, the possibility for minimum reorientation, the possibility for maximum reorientation and the possibility for bending.

According to another important characteristic of the invention, the simulation comprises a continuous mode of the simulation without stopping in the presence of interference detected between the three-dimensional geometric model of the tube and the three-dimensional geometric model of the bending machine and associated mechanical tools, thus comprising a simulation that corresponds to a succession of bends starting with one or the other of the tube extremities and that delivers a file containing the result of the simulation.

Alternatively, the simulation comprises a step-by-step mode comprising stopping the simulation in the presence of each detected interference, an option for stopping the simulation in progress, a simulation for each tube extremity, an option for continuing the simulation in progress at the detection position, an option for analyzing and visually displaying the detected interference, and writing of the detected interferences into a result file and displaying the said file.

Another object of the present invention is a device for simulating bending of a tube by means of at least one bending machine comprising:
processing means for obtaining a set of tube data related to the definition of the three-dimensional model of the tube to be bent;
retrieving means for obtaining at least one set of technological data related to the parameters of at least one bending machine, associated mechanical tools and/or tube material;
calculating means for calculating at least one cycle of bending commands related to at least one manufacturing parameter of the tube as a function of the set of tube data and of the set of technological data;
obtaining means for obtaining at least one three-dimensional geometric model of at least one bending machine and associated mechanical tools as a function of at least one parameter derived from the cycle of bending commands calculated in this way;
simulating means that are capable, according to the cycle of bending commands calculated in this way, of obtaining a three-dimensional and kinematic simulation of the tube-bending process represented in this way by the set of tube data by means of the bending machine and associated mechanical tools represented in this way by the corresponding three-dimensional geometric model;
verifying means for verifying the possibility of manufacturing the tube by means of the bending machine and associated mechanical tools during the three-dimensional and kinematic simulation obtained in this way; and delivering a set of result data related to the manufacturability of the tube by the bending machine and the associated mechanical tools simulated in this way.

Another object of the present invention is an information medium that can be read by an information-processing system and that may be completely or partly removable, especially a CD ROM or a magnetic medium, such as a hard disk or floppy, or a transmittable medium, such as an electric or optical signal, characterized in that it contains instructions of a computer program permitting implementation of a method such as described hereinabove when this program is loaded and executed by an information-processing system.

Finally, another object of the present invention is a computer program stored on an information medium, the said program containing instructions for implementation of a method such as described hereinabove when this program is loaded and executed by an information-processing system.

Other characteristics and advantages of the invention will become apparent in the light of the detailed description hereinafter and of the drawings, wherein:

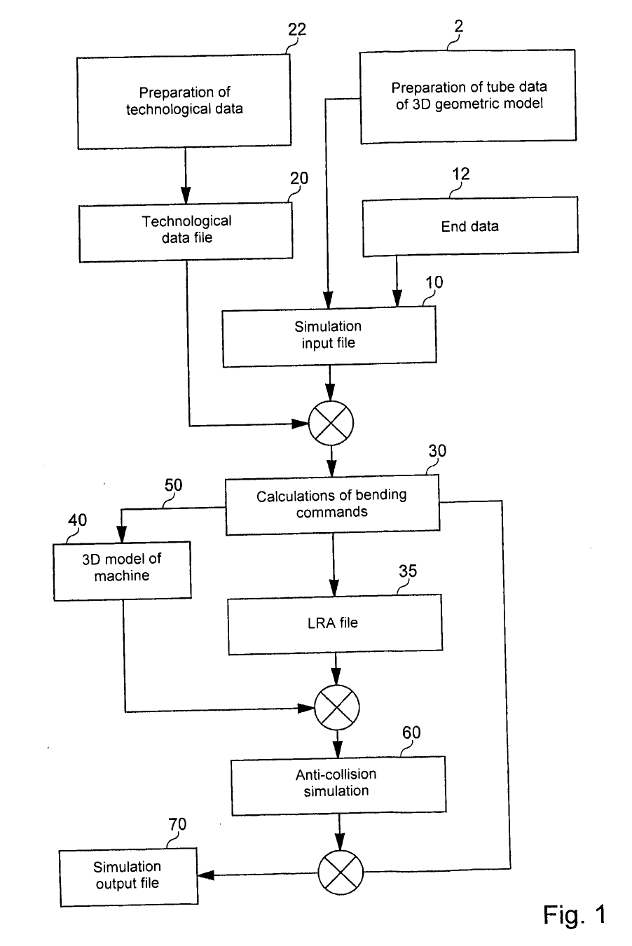

FIG. 1 schematically illustrates the architecture of the device capable of implementing the main steps of the simulation method according to the invention;

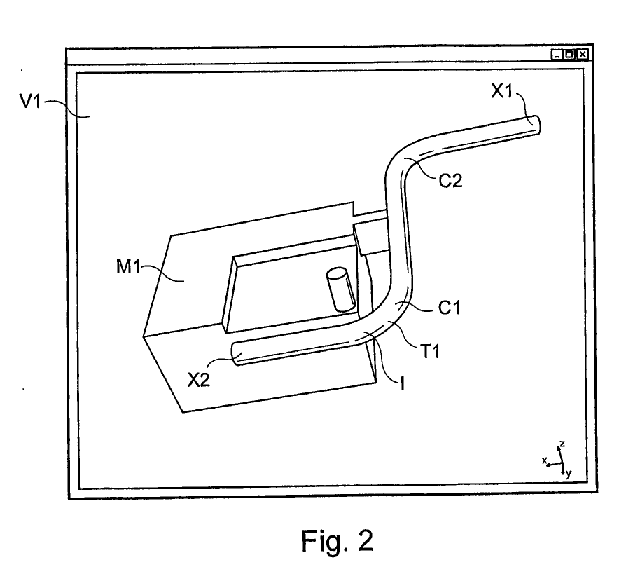

FIG. 2 is a working environment of a CAD software program accessible in the design department and showing the detection of an interference between the three-dimensional geometric model of a bending machine and the three-dimensional geometric model of a tube during a simulation according to the invention;

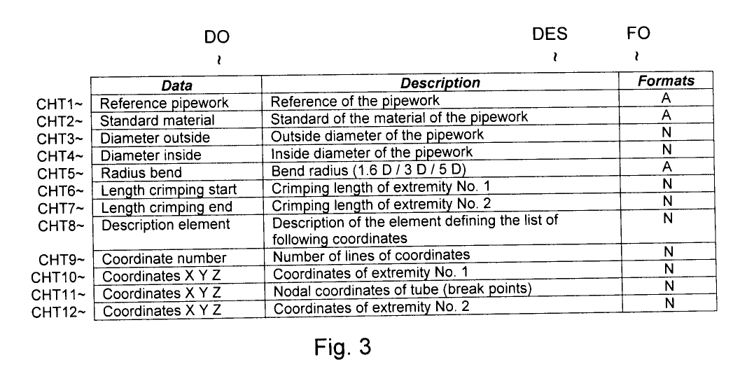

FIG. 3 schematically represents the description and structure of fields representative of the data of the set of tube data according to the invention;

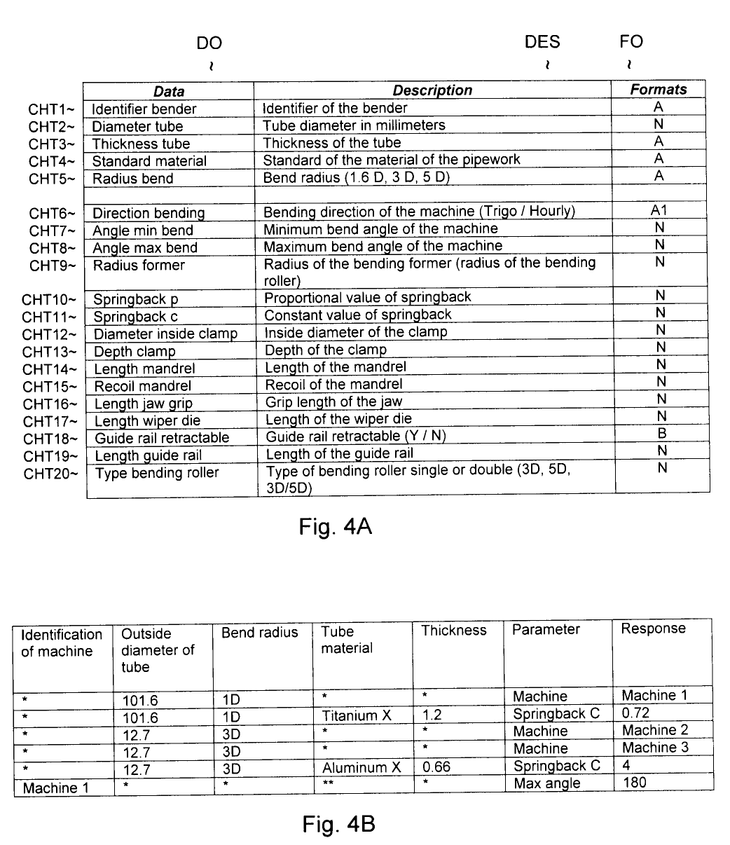

FIGS. 4A and 4B schematically represent the description and structure of data fields of the set of technological data according to the invention;

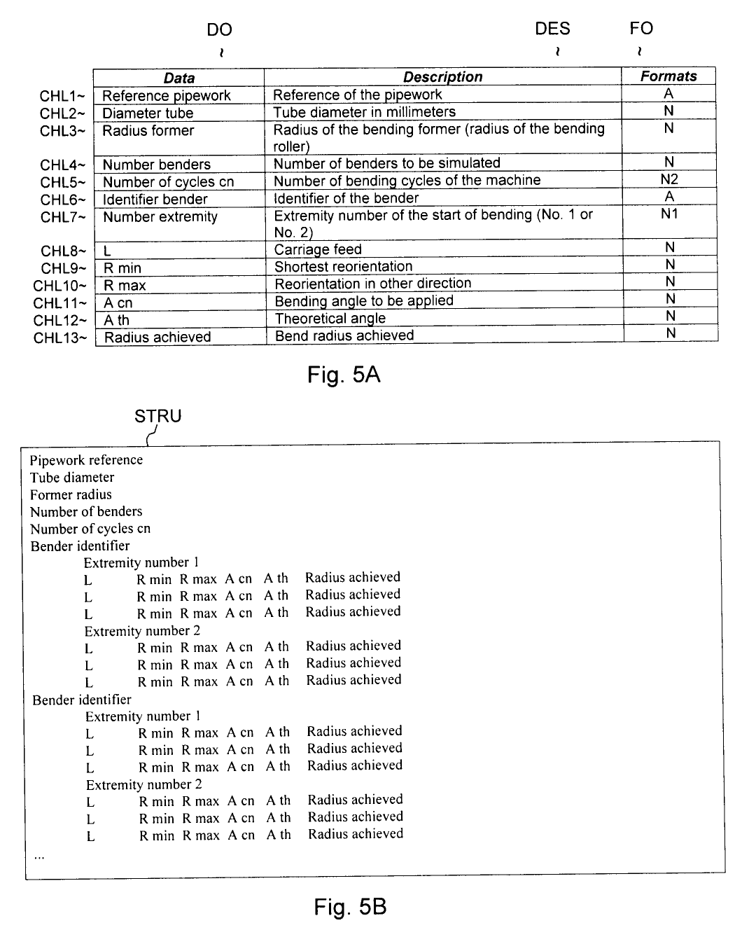

FIGS. 5A and 5B schematically represent the description and structure of data of the cycle of bending commands according to the invention; and

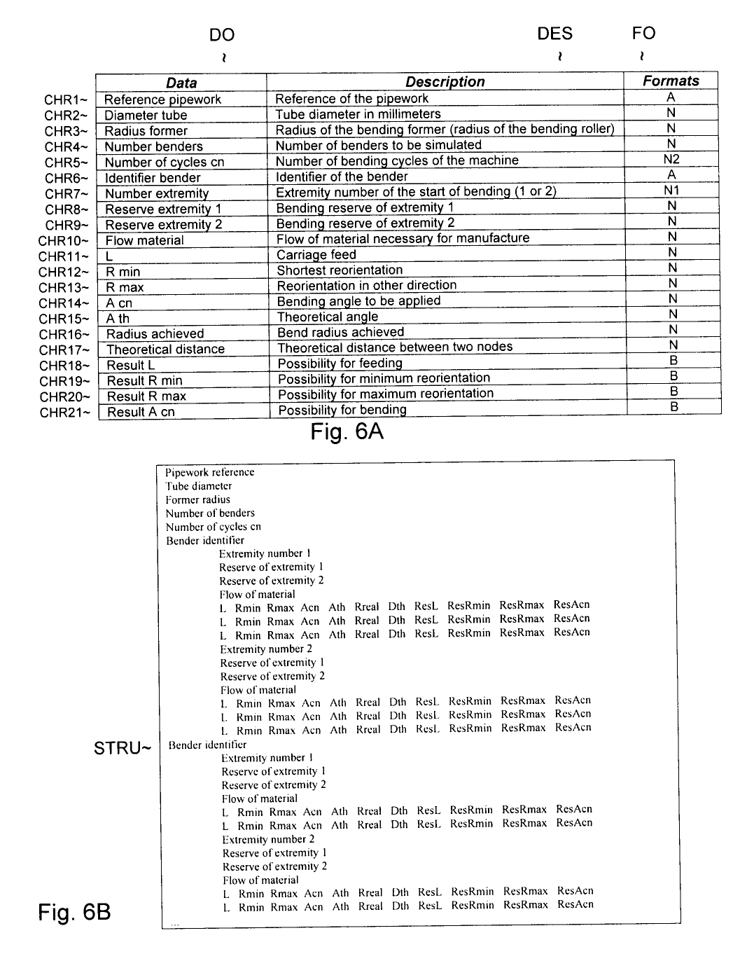

FIGS. 6A and 6B schematically represent the description and structure of data of the set of result data according to the invention.

Referring to FIG. 1, the user defines the description of the three-dimensional geometric model of the tube to be processed.

For that purpose, the user may extract data about the tube or the associated pipework using specific functions or through a man/machine interface using a computer-assisted design system, for example of the CATIA (trade name) type.

The preparation of tube data makes it possible to preprocess data used for simulation of bending and for manufacture of the part, and to convert them to text format, as will be described in more detail hereinafter.

For each simulation according to the invention, and depending on its origin, an extraction module 2 can be launched to furnish a file 10 containing the three-dimensional characteristics of the naked or equipped tube.

In the case of an equipped tube, a supplemental file 12 makes it possible to take into account data relating to the joints installed at the tube extremity and to calculate the coordinates of the extremities of the corresponding naked tube.

At the end of this step of preparation and design, the user in this way obtains at least one set of tube data 10 related to the definition of the three-dimensional model of the tube to be bent.

Referring to FIG. 3, file 10 relating to the tube data contains information belonging to the group formed by:
the tube reference CHT1;
the material CHT2;
the outside diameter CHT3;
the inside diameter CHT4;
the bend radius CHT5, which is identical for all elbows of the tube (the tooling is not changed during bending) and is expressed by a ratio relative to the tube diameter (1.6D/3D/5D);
the crimping length necessary for installation of a joint at extremity No. 1 of the tube CHT6;
the crimping length necessary for installation of a joint at extremity No. 2 of the tube CHT7;
the description of tube elements CHT8; and
the number of X, Y and Z coordinates CHT9 relative to extremity No. 1 CHT10, relative to extremity No. 2 CHT12 and the X, Y and Z coordinates of the break points of the tube CHT11.

The table illustrating the structure of file 10 contains a “data” column DO, a “description” column DES and a “format” column FO. The “format” field FO may be in alphanumeric format A, in numeric format N or in trigonometric format T.

The parameter CHT9 is not necessary in the case of an XML file.

More precisely, the parameter CHT8 describes the type of point referenced by the coordinates (CHT10, CHT11, CHT12). There are several types. The simplest case is represented by the following XML file excerpt:

```
− <POINTS>
  − <POINT TYPE=“Extremity” NUM=“01”>
      <COORDS x=“140.000000” y=“100.000000”
        z=“0.000000” />
      <LOCAL_COORDS x=“0.000000” y=“0.000000”
        z=“0.000000” />
    </POINT>
  − <POINT TYPE=“Break” NUM=“01”>
      <COORDS x=“140.000000” y=“100.000000”
        z=“1910.000000” />
      <LOCAL_COORDS x=“1910.000000” y=“0.000000”
        z=“0.000000” />
    </POINT>
  − <POINT TYPE=“Break” NUM=“02”>
      <COORDS x=“2850.000000” y=“100.000000”
        z=“1910.000000” />
      <LOCAL_COORDS x=“1910.000000” y=“2710.000000”
        z=“0.000000” />
    </POINT>
  − <POINT TYPE=“Extremity” NUM=“02”>
      <COORDS x=“2850.000000” y=“−1070.000000”
        z=“1910.000000” />
      <LOCAL_COORDS x=“1910.000000” y=“2710.000000”
        z=“−1170.000000” />
    </POINT>
  </POINTS>
```

The parameter CHT8 actually contains two sub-parameters, TYPE and NUM. The parameter CHT8 is of type A (alphanumeric).

In this example, the points of “extremite or extremity” type indicate an extremity of the tube, and the points of “cassure or break” type represent break points.

To execute a bending simulation, the file to be processed contains at least two points of “extremity” type and one point of “break” type.

Reference again is made to FIG. 1.

After the tube file 10 has been obtained, or while it is being obtained, the user determines at least one set of technological data 20 related to the parameters of at least one bending machine, associated mechanical tools and/or tube material.

File 20 will make it possible to undertake a choice of the machine or to characterize each machine according to different criteria.

File 20 contains technological data, which are data related to parameters relating to bending machines, to associated tools (mandrel, jaw, guide rail, wiper die) and also to tube materials (material standard, springback or elastic recovery).

In practice, a module 22 makes it possible to extract all of the technological data 20 of an application that contains all of the corresponding data in database form (not illustrated).

Referring to FIGS. 4A and 4B, file 20 relating to the technological data contains information belonging to the group formed by:
the machine reference CHM1,
the tube material CHM4,
the tube diameter CHM2,
the tube thickness CHM3,
the bend radius CHM5,
the bending direction CHM6,
the minimum and maximum bend angles CHM7 and CHM8,
the bending former CHM9,
the proportional and constant values CHM10 and CHM11 of springback,
the dimensions, the mutual position and the possibility of repositioning of the mechanical tools (clamps, mandrel, jaw, wiper die, guide rail, bending roller) of the bending machine CHM12 to CHM20.

Referring to FIG. 4B, there is described the table illustrating the structure of file 20.

The table of FIG. 4B is looked up in the following manner:

If the tube has a diameter of 101.6 and a bend radius of 1D, then it can be made on machine 1. If the diameter is 12.7 and the bend radius is 3D, then the tube can be made on machine 2 or on machine 3. For a diameter of 12.7, a bend radius of 3D on aluminum of 0.66 thickness, the constant springback coefficient (elastic recovery) to be taken into account is 4 regardless of the machine under consideration. Finally, machine 1 is capable of bending at a maximum angle of 180° regardless of the tube characteristics.

This data organization makes it possible quickly to select the machines in the existing pool and to input the elements useful for the simulation by interrogation of file 20 via filters.

Consequently, at the end of interrogation of file 20, the user has defined, as a function of tube characteristics, one or more machines that are “capable a priori” and the bending parameters associated with each of these machine/tube combinations, namely, for example:
the gripping length of the jaw;
the length of the wiper die;
the length of the guide rail;
the springback coefficients (elastic recovery) to be used, etc.

This set of data relating to each pair comprising a machine and preselected tube is simulated according to the invention.

Reference again is made to FIG. 1.

After tube data file 10 and technological data file 20 have been obtained, the user can establish the bending simulation according to the invention.

In step 30 of the method according to the invention, it is provided to calculate at least one cycle of bending commands 35 related to at least one manufacturing parameter of the tube as a function of the set of tube data 10 and of the set of technological data 20 obtained in this way.

Then there is obtained at least one three-dimensional geometric model of at least one bending machine and of associated mechanical tools 40 as a function of at least one manufacturing parameter 50 derived from the cycle of bending commands calculated in this way 30.

According to the cycle of bending commands calculated in this way 35, the method makes it possible to obtain a three-dimensional and kinematic simulation 60 of the tube-bending process represented in this way by the set of tube data 10 by means of the bending machine and associated mechanical tools represented in this way by the corresponding three-dimensional geometric model 40.

It is then provided to verify the possibility of manufacturing the tube by means of at least one bending machine and associated mechanical tools during the three-dimensional and kinematic simulation 60 obtained in this way; and to deliver a set of result data 70 related to the manufacturability of the tube by the bending machine and the associated mechanical tools simulated in this way.

Referring to FIGS. 5A and 5B, file LRA 35 has a structure STRU conforming with that of files 10 and 20, and contains information belonging to the group formed by:
the tube reference CHL1,
the tube diameter CHL2,
the radius of the bending former CHL3,
the number of bending machines to be simulated CHL4,
the number of bending cycles of the machine CHL5,
the machine identifier CHL6,
the number of the tube extremity CHL7,
the carriage feed CHL8,
the minimum reorientation CHL9,
the maximum reorientation CHL10,
the bend angle to be applied CHL11,
the theoretical bend angle CHL12, and
the achieved bend radius CHL13.

For example, the calculations of bending cycles 30 are subdivided in the following order:

1) calculation of the tube thickness CHM3;

2) search for the proportional value of the springback CHM10 and of the constant value of the springback CHM11 as a function of the material standard of the tube CHM4, of the tube diameter CHM2, of the tube thickness CHM3 and of the bend radius CHM5;

3) search for the former radius CHM9 and the gripping length of the jaw CHM16 as a function of the tube diameter CHM2 and of the bend radius CHM5;

4) among the n machines of the pool (here n=CHL4), search for bending machines capable of achieving manufacture of the tube as a function of the diameter CHM2;

5) search for parameters associated with each of the bending machines under consideration;

6) calculation of the theoretical distances as a function of the X, Y and Z coordinates of the tube elements CHT10, CHT11, CHT12 in both bending directions. The distances concern: the distance D relative to the distance between two nodal points, the distance R relative to the reorientation CHL8 (or in other words, turning of the tube relative to itself) and the distance A relative to the theoretical angle CHL12.

Also provided is a check of the minimum lengths between bends to allow clearance for bending and crimping jaws. This check establishes the following calculations:
calculation of the radii CHL13 achieved as a function of the springbacks of the former radius CHL3 and of the theoretical angle CHL12,
calculation of the theoretical distances as a function of the real radius CHL13, or in other words the distance L CHL8, which is the length of the straight part corresponding to the theoretical length of the straight part defined in the three-dimensional geometric model of the tube 10,
check of the lengths of the first and last straight parts sufficient for crimping,
check of the lengths of the straight parts strictly larger than the length of the jaw.

In the case of validation, other calculations are performed for the chosen bending machines:
calculation of the distances L, R, A corresponding respectively to the fields of file 35, CHL8, CHL9, CHL10, CHL11, CHL12 in both bending directions as a function of the proportional and constant springbacks CHM10 and CHM11 respectively of the former radius CHL3 and of the bend angle CHM7 and CHM8,
calculation of the reserves CHR8, CHR9 necessary for bending—it is to be noted that only the starting reserve has an influence on the bending simulation and a possible collision.
starting reserve as a function of the length of the jaw,
end-of-function reserve: of the length of the jaw, of the former radius, of the length of the guide bar if it is not retractable, of the length of the wiper die CHM17, of the clamp depth CHM13, of the inside diameter of the clamp CHM12, of the inside tube diameter CHT4, of the length of the mandrel CHM14, of the mandrel recoil CHM15, of the last feed and of the developed length of the last elbow, and
calculation of the outputs for both bending directions.

The set of data derived from these calculations of bending commands 30 stored in a text file 35 designated LRA, which mainly characterizes the technological data which are the feeds L, the reorientations R and the bends A.

These data 35 are input data for the anticollision simulation part of the method according to the invention.

As a function of at least one parameter 35 derived from the preceding calculations 30, the method searches in a catalog for the machines and the corresponding tools. The objective is to furnish a set of three-dimensional machine/tools geometries 40 for anticollision simulation as a function of parameters related to manufacture of the tube.

In this way, at the end of steps 30 and 40, the method has data that make it possible to obtain a three-dimensional and kinematic simulation 60 of the process of bending of the tube represented in this way by the set of tube data 10 by means of a bending machine and associated tools represented in this way by the set of technological data 20.

The method then undertakes a kinematic simulation of the bends in order to monitor the manufacturability of the elemental pipework relative to a pool of bending machines.

In this way the method makes it possible to determine the valid sets and to identify the sets that are not possible, and in turn the presence or otherwise of collisions during the simulation.

Verification of anticollision of the tube relative to the pool of possible bending machines and to the tools used is undertaken in both bending directions of the tube, while taking into account the springback effect (elastic recovery) for bending.

For a given bending machine, the naked tube is presented on the bending roller and the jaw, then the previously calculated bending cycles 30 are reconstituted one by one, taking into account the elastic deformation due to springback.

In each of these operations, the simulation verifies the presence of interferences between the three-dimensional geometric model of the pipework 10 and that of the bending machine 40.

The verification is also undertaken on the tools that may cause collisions more frequently, such as a single or double bending roller during reorientations and the bending arms during springback at the bend.

This simulation is undertaken for both ends of the pipework, then it is repeated with all of the available bending machines represented by the sets 35 furnished during the preceding calculations.

The simulation furnishes a result file 70 originating from completed calculations of the response of the simulation to the found interferences. This file is suitable for application to the corresponding bending machine in production mode.

Referring to FIGS. 6A and 6B, the result file 70 has a structure STRU conforming with that of files 10, 20 and 35, and contains information belonging to the group formed by:
the tube reference CHR1,
the tube diameter CHR2,
the radius of the bending former CHR3,
the number of bending machines to be simulated CHR4,
the number of bending cycles of the machine CHR5,
the machine identifier CHR6,
the number of the tube extremity CHR7,
the bending reserve relative to the first extremity CHR8,
the bending reserve relative to the second extremity CHR9,
the flow of materials necessary for manufacture CHR10,
the carriage feed CHR11,
the minimum reorientation CHR12,
the maximum reorientation CHR13,
the bend angle to be applied CHR14,
the theoretical bend angle CHR15,
the achieved bend angle CHR16,
the theoretical distance between two nodes CHR17,
the feed possibility CHR18,
the minimal reorientation possibility CHR19,
the maximal reorientation possibility CHR20, and
the bending possibility CHR21.

Following the simulation method, there can be automatically generated at least one sequence of bending commands intended for the bending machine simulated in this way and deduced from the cycle of bending commands 35 validated at the end of the simulation.

As regards the design department, visual information about the feasibility of the tube can be furnished.

For example (FIG. 2), in the case of negative verification, or in other words in the case of presence of collision I between the three-dimensional geometric model of the bending machine M1 and the three-dimensional geometric model of the tube T1 having an extremity X1, an extremity X2, an elbow C1 and an elbow C2, it is provided that, in the design department, at least one parameter of the set of tube data 10 will be modified and the step of simulation will be repeated with the set of data modified in this way.

In practice, the simulation method is repeated for each bending machine, until there is obtained at least one positive result demonstrating the manufacturability of the tube by means of a bending machine belonging to the said pool of bending machines.

The user is able to visualize the different bending cycles continuously or step-by-step for the purpose of more detailed analysis.

During detection of a collision, the user is able to visualize the interference (FIG. 2) in a software environment V1 of a CAD tool such as Catia version 5 software.

For example, the bending simulation is launched by way of workshops and of an icon in the toolbar of the CAD software program.

In production, launch of the bending simulation can be established in the design and production application, in order to verify a tube relative to a machine pool. This launch can be initiated by an “anticollision action” button.

In the case of mass processing for a new machine, the bending simulation can be launched by a “validate” button of the man/machine interface.

The simulation can be visualized either continuously or in step-by-step mode in a dialog box.

The software platform is provided with an environment that is traditional in the field of computer-assisted design (CAD).

1. A method for simulating bending of a tube by means of at least one bending machine, comprising the following steps:
obtaining at least one set of tube data (10) related to the definition of the three-dimensional geometric model of the tube to be bent;
obtaining at least one set of technological data (20) related to parameters of at least one bending machine, associated mechanical tools and/or tube material;
calculating at least one cycle of bending commands (30, 35) related to at least one tube-manufacturing parameter as a function of the set of tube data (10) and of the set of technological data (20) obtained in this way;
obtaining at least one three-dimensional geometric model (40) of at least one bending machine and associated mechanical tools as a function of at least one parameter (50) derived from the cycle of bending commands calculated in this way (30, 35);
in accordance with the cycle of bending commands calculated in this way (35), obtaining a three-dimensional and kinematic simulation of the process in which the tube represented in this way by the set of tube data (10) is bent by means of at least one bending machine and associated mechanical tools represented in this way by the corresponding three-dimensional geometric model (40);
verifying the possibility of manufacturing the tube by means of at least one bending machine and associated mechanical tools during the three-dimensional and kinematic simulation obtained in this way; and delivering a set of result data (70) related to the manufacturability of the tube by the bending machine and the associated mechanical tools simulated in this way.

2. A method according to claim 1, wherein, in the event of negative verification, it provided that at least one parameter of the set of tube data (10) is modified and the simulation step is repeated with the set of tube data modified in this way.

3. A method according to claim 1, wherein, in the case of positive verification, it provided that at least one sequence of bending commands deduced from the cycle of corresponding bending commands and intended for the bending machine simulated in this way is generated automatically.

4. A method according to claim 1, wherein the method is applied to a pool of bending machines, and wherein the following steps are additionally provided:
obtaining at least one three-dimensional geometric model (40) for at least each bending machine and associated mechanical tools as a function of at least one parameter derived from the cycle of bending commands calculated in this way;
repeating the simulation for each three-dimensional geometric model (40) obtained in this way until obtaining at least one positive result that demonstrates the manufacturability of the tube by means of a bending machine and associated mechanical tools belonging to the said pool of bending machines.

5. A method according to claim 4, wherein the simulation step is implemented in the design department starting with the phase of definition of the tube.

6. A method according to claim 1, wherein the method is implemented on the production line in order to prepare for manufacture of the tube

7. A method according to claim 1, wherein each set of tube data (10) contains information belonging to the group formed by information on the tube reference (CHT1), the tube material (CHT2), the outside diameter (CHT3), the inside diameter (CHT4), the bend radius (CHT5), the crimping length necessary for installation of a joint at extremity No. 1 of the tube (CHT6), the crimping length necessary for installation of a joint at extremity No. 2 of the tube (CHT7), the description of the tube elements (CHT8), the number of X, Y, Z coordinates (CHT9), the X, Y, Z coordinates of extremity No. 1 (CHT10), of extremity No. 2 (CHT12) and the break points of the tube (CHT11).

8. A method according to any one of the preceding claims, wherein each set of technological data (20) contains information belonging to the group formed by information on the machine reference (CHM1), the tube material (CHM4), the tube diameter (CHM2), the tube thickness (CHM3), the bend radius (CHM5), the bending direction (CHM6), the minimum and maximum bend angles (CHM7, CHM8), the dimensions, the bending former (CHM9), the proportional and constant values of springback (CHM10, CHM11), the mutual position and the possibility of repositioning of mechanical tools of the bending machine (CHM12 to CHM20).

9. A method according to claim 1, wherein the cycle of commands (35) comprises information belonging to the group formed by the tube reference (CHL1), the tube diameter (CHL2), the radius of the bending former (CHL3), the number of bending machines to be simulated (CHL4), the number of bending cycles of the machine (CHL5), the machine identifier (CHL6), the number of the tube extremity (CHL7), the carriage feed (CHL8), the minimum reorientation (CHL9), the maximum reorientation (CHL10), the bend angle to be applied (CHL11), the theoretical bend angle (CHL12), the bend radius achieved (CHL13).

10. A method according to claim 1, wherein the set of result data (70) includes information belonging to the group formed by the tube reference (CHR1), the tube diameter (CHR2), the radius of the bending former (CHR3), the number of bending machines to be simulated (CHR4), the number of bending cycles of the machine (CHR5), the machine identifier (CHR6), the number of the tube extremity (CHR7), the bending reserve relative to the first extremity (CHR8), the bending reserve relative to the second extremity (CHR9), the flow of materials necessary for manufacture (CHR10), the carriage feed (CHR11), the minimum reorientation (CHR12), the maximum reorientation (CHR13), the bend angle to be applied (CHR14), the theoretical bend angle (CHR15), the bend radius achieved (CHR16), the theoretical distance between two nodes (CHR17), the possibility for feeding (CHR18), the possibility for minimum reorientation (CHR19), the possibility for maximum reorientation (CHR20) and the possibility for bending (CHR21).

11. A method according to claim 1, wherein the simulation comprises a continuous mode of the simulation without stopping in the presence of interference detected between the three-dimensional geometric model of the tube and the three-dimensional geometric model of the bending machine and associated mechanical tools, thus comprising a simulation that corresponds to a succession of bends starting with one or the other of the tube extremities and that delivers a file containing the result of the simulation.

12. A method according to claim 1, wherein the simulation comprises a step-by-step mode comprising stopping the simulation in the presence of each detected interference, an option for stopping the simulation in progress, a positioning for each tube extremity, an option for continuing the simulation in progress at the detection position, an option for analyzing and visually displaying the detected interference, and writing of the detected interferences into a result file and displaying the said file.

13. A device for simulating bending of a tube by means of at least one bending machine, comprising:
processing means for obtaining a set of tube data related to the definition of the three-dimensional model of the tube to be bent (10);
retrieving means for obtaining at least one set of technological data related to the parameters of at least one bending machine and associated mechanical tools and/or tube material (20);
calculating means for calculating at least one cycle of bending commands (30, 35) related to at least one manufacturing parameter of the tube as a function of the set of tube data (10) and of the set of technological data (20);
obtaining means for obtaining at least one three-dimensional geometric model (40) of at least one bending machine and associated mechanical tools as a function of at least one parameter (50) derived from the cycle of bending commands calculated in this way (30, 35);
simulating means that are capable, according to the cycle of bending commands calculated in this way (35), of obtaining a three-dimensional and kinematic simulation of the tube-bending process represented in this way by the set of tube data (10) by means of the bending machine and associated mechanical tools represented in this way by the corresponding three-dimensional geometric model (40);
verifying means for verifying the possibility of manufacturing the tube by means of at least one bending machine and associated mechanical tools during the three-dimensional and kinematic simulation obtained in this way; and delivering a set of result data (70) related to the manufacturability of the tube by the bending machine and the associated mechanical tools simulated in this way.

14. An information medium that can be read by an information-processing system and that may be completely or partly removable, especially a CD ROM or a magnetic medium, such as a hard disk or floppy, or a transmittable medium, such as an electric or optical signal, characterized in that it contains instructions of a computer program permitting implementation of a method according to any one of claims 1 to 12 when this program is loaded and executed by an information-processing system.

15. A computer program stored on an information medium, wherein the said program contains instructions for implementation of a method according to any one of claims 1 to 12 when this program is loaded and executed by an information-processing system.
